(19) United States
(12) Patent Application Publication
(10) Pub. No.: US 2005/0231811 A1
(43) Pub. Date: Oct. 20, 2005

(54) Projector

(75) Inventor: Yasuyuki Miyata, Saitama-Shi (JP)

Correspondence Address: YOUNG & THOMPSON, 745 SOUTH 23RD STREET, 2ND FLOOR, ARLINGTON, VA, 22202, US

(73) Assignee: FUJINON CORPORATION, SAITAMA-SHI (JP)

(21) Appl. No.: 11/083,980

(22) Filed: Mar. 21, 2005

(30) Foreign Application Priority Data
Mar. 31, 2004 (JP) 2004-105508

(51) Int. Cl. G02B 27/14

(52) U.S. Cl. 359/634

(57) ABSTRACT

An off-axis type projector includes a color separating unit for color-separating light beams emitted from an illumination light source, a color combining unit for combining the light beams thus color-separated and plural image display elements for giving image information to the respective light beams color-separated by the color separating unit and reflecting the light beams to the color combining unit, wherein the color separating unit and the color combining unit include a cross dichroic prism or cross dichroic plate achieved by combining plural prism blocks or plates so that dichroic films different in wavelength selectivity are arranged in a cross shape, and the intersection line between the dichroic films is perpendicular to the short sides of rectangular display frames of the image display elements and parallel to a horizontal direction when the device is mounted.

This application is based on Japanese Patent application JP 2004-105508, filed Mar. 31, 2004, the entire content of which is hereby incorporated by reference. This claim for priority benefit is being filed concurrently with the filing of this application.

### BACKGROUND OF THE INVENTION

1. Technical Field of the Invention

The presents invention relates to an off-axial type projector for making color-separated light beams incident to plural image display elements, combining the light beams of respective colors which are added with image information, and projecting the light beams thus combined.

2. Description of the Related Art

A projector with three-imager is equipped with a color separating unit for separating white light emitted from a light source into light beams of R, G and B colors, three image display elements for modulating the respective three color light beams thus separated on a pixel basis, and a color combining unit for combining the respective color light beams to which image information are applied by the image display elements. As the color separating unit and the color combining unit are known a construction achieved by combining a dichroic mirror and a polarizing beam splitter (see JP-A-2003-29331), a construction comprising plural dichroic mirrors for carrying out color separation and a cross dichroic prism for carrying out color combination (see JP-A-2003-5167), etc.

An optical system used in the above-described related arts is called as an on-axis type, and a light beam is incident vertically to a reflection type or transmission type image display element, and the incident light and the reflected light (or transmitted light) propagate along the coaxial optical path. On the other hand, an optical system in which a light beam is made incident to a reflection type image display element in an oblique direction and reflected light propagates along an optical path different from that of incident light is called as an off-axis type, and it is used in a single-plate type projector having an image display device such as a digital mirco-mirror device or the like.

The related art projector with three-imager generally uses the on-axis type disclosed in JP-A-2003-29331 and JP-A-2003-5167. Therefore, many expensive optical parts as described above are needed for the color separating unit and the color combining unit, and thus it is difficult to reduce the price of products. Therefore, a projector with three-imager using the off-axis type has been proposed to reduce the number of optical parts needed for the color separating unit and the color combining unit (for example, see JP-A-2003-98315). According to this three-imager and off-axis type projector, color-separated light beams are made incident to an image display element in an oblique direction, and thus the propagation direction of the light beams incident to the image display device intersects to the propagation direction of the light beams emitted from the image display device in a V-shape.

However, in the three-imager and off-axial type projection described above, particularly when a reflection liquid crystal display element (for example, LCOS) is used as the image display element, the light beam is incident to the liquid crystal display element in an oblique direction. Therefore, when the intersection angle between the normal direction of the liquid crystal screen and the incident direction of the light beam is increased, the light amount and the contrast are lowered. Accordingly, it is required to dispose the image display element so that the distance between the image display element and each of the color separating unit and the color combining unit is kept large and the incident angle of the light beam is suppressed. In order to satisfy this requirement, a projection lens is required to have a large back focus, and thus the projection lens must be designed in large scale, which disturbs compact design and low cost of the projector.

Furthermore, as shown in the projector 40 of FIG. 4, a cross dichroic prism having a rectangular column shape (hereinafter referred to as XDP) 41 is provided as the color separating unit and the color combining unit. XDP 41 is designed so that a portion having a color separating action and a portion having a color combining portion are disposed vertically to each other. Three reflection type liquid crystal panels 42 are disposed obliquely with respect to the side surface of XDP 41. The illumination optical system 43 is disposed below the projection lens 44 so that light beams are incident to XDP 41 in an oblique direction. The optical axis of the illumination optical system 43 is bent by using a mirror 45 so that the dimension of the projector 40 in the vertical direction is suppressed. However, since the illumination optical system 43 is disposed at the lower side of the projection lens 44, and thus the projector is designed so as to be large in the vertical direction. Therefore, the compact design which would be achieved by omitting the optical parts cannot be sufficiently achieved as compared with the on-axis type projector. The present invention has been implemented in view of the foregoing situation.

### SUMMARY OF THE INVENTION

An object of the invention is to provide a projector which can reduce back focus required to a projection lens and perform both of reduction in cost and miniaturization by using an off-axis type.

In order to attain the above object, an off-axis type projector comprising a color separating unit for color-separating light beams emitted from an illumination light source, a color combining unit for combining the light beams thus color-separated and plural image display elements for giving image information to the respective light beams color-separated by the color separating unit and reflecting the light beams to the color combining unit, an incidence direction of the light beams color-separated by the color separating unit to the image display elements being different from an incidence direction of the light beams reflected from the image display elements to the color combining unit, is characterized in that the color separating unit and the color combining unit comprises a cross dichroic prism or cross dichroic plate achieved by combining plural prism blocks or plates so that dichroic films different in wavelength selectivity are arranged in a cross shape, and the intersection line between the dichroic films is perpendicular to the short sides of rectangular display frames of the image display elements and parallel to a horizontal direction when the device is mounted.

Furthermore, the color separating unit and the color combining unit preferably comprises one cross dichroic prism or cross diachronic plate.

According to the present invention, the image display element is disposed so that the intersection line between the dichroic films of the color separating unit and the color combining unit is perpendicular to the short sides of rectangular display frames of the image display elements, so that each side of the bottom surface of the cross dichroic prism or the width of the cross dichroic plate is reduced, and thus the distance between the projection lens and the image display elements can be reduced. That is, the back focus required to the projection lens can be reduced, and a condition advantageous to design a compact lens can be achieved. Furthermore, the cross dichroic prism or the cross dichroic plate is disposed so that the intersection line between the diachronic films is parallel to the horizontal direction, and thus the projection lens and the illumination optical system are disposed in the horizontal direction. Therefore, the dimension in the vertical direction can be reduced, and thus there can be achieved a projection suitable to use a rectangular screen which is long in the horizontal direction.

### BRIEF DESCRIPTION OF THE DRAWINGS

FIG. 1 is a perspective view showing an embodiment of the construction of a projector.

FIG. 2 is a plan view showing an embodiment of the construction of a projector.

FIGS. 3A and 3B are diagrams showing the difference in shape of a cross dichroic prism in accordance with the arrangement of liquid crystal panels.

FIG. 4 is a perspective view showing the construction of a related art projector.

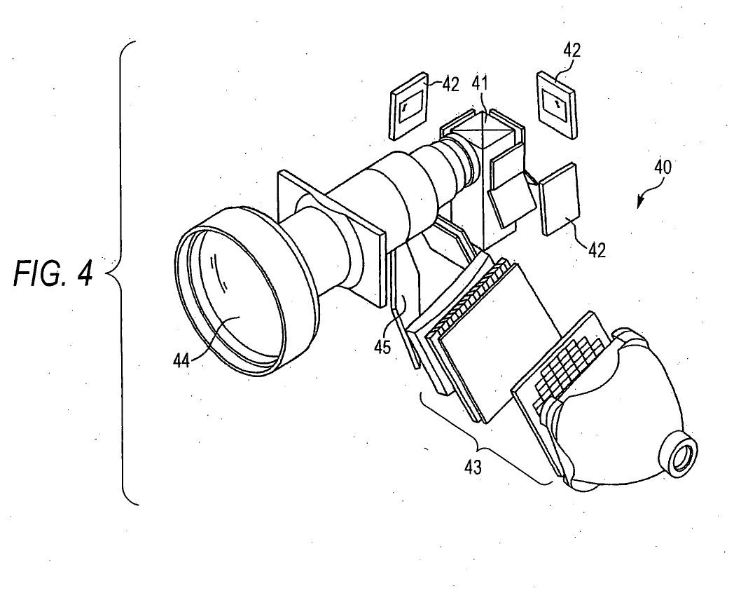

### DETAILED DESCRIPTION OF THE INVENTION

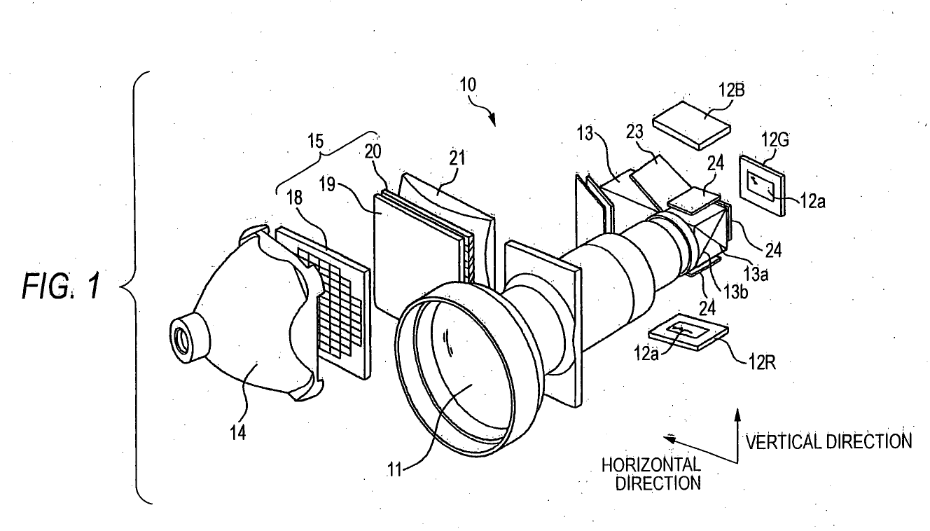

In FIG. 1, the projector 10 is equipped with a projection lens 11, three reflection type liquid crystal display panels 12R, 12G and 12B, XDP 13, an illumination lamp 14, and an illumination optical system 15. The illumination optical system 15 is constructed as a polarization transformation integrator optical system comprising a first lens array 18, a second lens array 19, a PBS array 20 and a superposition lens 21. The first-and second lens arrays 18 and 19 are designed so that micro-lenses whose shapes are similar to the shape of the liquid crystal display frames of the liquid crystal panels 12R to 12B are arranged in a matrix form. Illumination light flux radiated from the illumination lamp are divided into many light beams by the respective mirco-lenses, and each of the light beams thus divided forms a minute light source image on the PBS array 20.

The PBS array 20 comprises an assembly of prisms each of which comprises a polarization reflection film and a total reflection film which are alternately formed, and it efficiently converts random polarized light radiated from the illumination lamp 14 to S-polarized light, for example. The respective light beams which form light source images on the PBS array 20 are superposed on the respective liquid crystal display frames 12a of the liquid crystal panels 12R to 12B so that each of the liquid crystal panels is illuminated uniformly over the area from the center portion thereof to the peripheral portion thereof.

White illumination light flux emitted from the illumination optical system 15 is incident to the side surface of XDP 13 in an oblique direction and divided into red light (R light), green light (G light) and blue light (B light). XDP 13 comprises four rectangular prism blocks, and is constructed as a rectangular parallelepiped prism by joining the four rectangular prism blocks to one another so that the four ridge lines thereof which have right-angled apex angles face one another. Two kinds of dichroic films which constitute a red reflection face 13a for reflecting only R light and a blue reflection face 13b for reflecting only B light respectively are provided on the joint faces of the rectangular prisms so as to be orthogonal to each other in a cross form. Polarization plates 23, 24 are provided on the side surfaces of XDP 13. The respective color light beams separated by XDP 13 are passed through the respective polarization plates 23 to be enhanced in polarization degree, and then incident to the respective liquid crystal panels 12R to 12B.

The liquid crystal panels 12R to 12B modulate the respective color illumination light beams incident thereto to image light beams having image information. The respective color image light beams are reflected toward XDP 13, transmitted through the polarization plates 24 acting as analyzers and then incident to XDP 13. The respective color image light beams are combined with one another by XDP 13, and then emitted to the projection lens 11. The projection lens 11 comprises plural lenses. Some of the plural lenses are shifted with respect to the optical axis and the respective liquid crystal panels are disposed so as to be inclined with respect to the optical axis A2, thereby correcting distortion of a projected image.

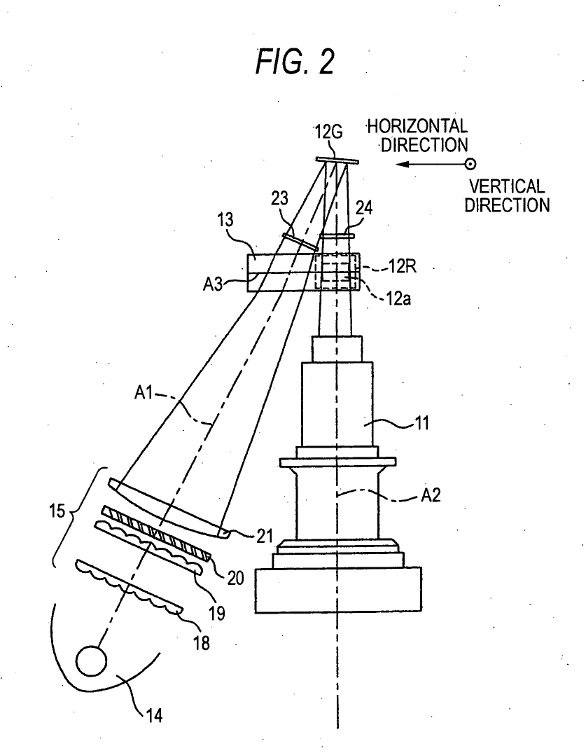

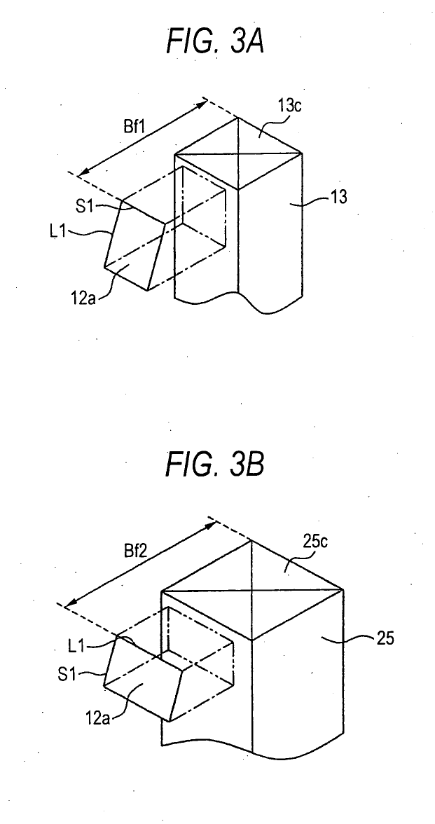

In FIG. 2, the projector 10 has an off-axis type optical system in which the optical axis A1 of the illumination optical system 15 and the optical axis A2 of the projection lens 11 intersect to each other substantially in V-shape, and the liquid crystal panels 12R to 12B are disposed so that the normal lines of the liquid crystal display frames 12a are not coincident with the optical axis A1 of the projection lens 11 and are inclined with respect to the side surfaces of XDP 13. The liquid crystal panels 12R to 12B are disposed so as to be spaced from the respective side surfaces of XDP 13 at a fixed distance and also so that the short sides S1 (see, FIG. 3A) of the rectangular liquid crystal display frames 12a each having an aspect ratio of 4:3 are perpendicular to the intersection line A3 of the dichroic films of XDP 13. The projection lens 11 and the illumination optical system 15 are arranged so as to be juxtaposed with each other along the horizontal direction, and the plane passing through the optical axes A1 and A2 is parallel to the horizontal direction of the screen. The liquid crystal panels 12R and 12B are provided above and below XDP 13 in the vertical direction, and the height dimension of the projector 10 is substantially equal to the distance between the liquid crystal panels 12R and 12B.

In FIG. 3A, since the respective liquid crystal panels are disposed so that the short sides S1 of the liquid crystal display frames are perpendicular to the intersection line A3, that is, the short sides S1 are parallel to the bottom surface 13c of XDP 13, the length of each side of the bottom surface 13c needed for XDP 13 corresponds to the length of the short side S1. On the other hand, in FIG. 3B, when XDP 25 having a bottom surface 25c parallel to the long sides L1 of the respective liquid crystal panels is used, the length of each side of the bottom surface 25c corresponds to the length of the long side L1 of the liquid crystal display frame 12a. Thus XDP 13 has a smaller bottom area than XDP 25. Accordingly, the distances from each liquid crystal panel to the projection lens 11 in both the cases, that is, the length BF1 of the back focus needed to the projection lens 11 when XDP 13 is used and the length Bf2 of the back focus needed to the projection lens 11 when XDP 25 is used are set so that Bf1 is smaller than Bf2. The distances from XDP 25 to the liquid crystal display frame 12a in FIGS. 3A and 3B are equal to each other, and the dimension of the projector having XDP 13 in the optical axis A2 is reduced.

The present invention is not limited to the above embodiment in which the liquid crystal display panels are used as the image display elements, and the same effect can be achieved insofar as a reflection projector using a light switch such as another light valve, a digital micro-mirror device or the like is constructed. Furthermore, the optical member used as the color separating unit, the color combining unit is not limited to the diachronic prism, but it may be a dichroic plate in which glass plates having dichroic films formed thereon are combined with each other in a cross shape. The present invention is not limited to the embodiment in which the color combining unit and the color separating unit are constructed by one cross dichroic prism or cross dichroic plate, but the optical member may be designed so that the color combining unit and the color separating unit are separated from each other.

1. An off-axis type projector comprising:
a color separating unit for color-separating light beams emitted from an illumination light source;
a color combining unit for combining the color-separated light beams;
plural image display elements for giving image information to the color-separated light beams and reflecting the color-separated light beams to the color combining unit,
wherein the color separating unit and the color combining unit each has a structure in which dichroic films different in wavelength selectivity are in a cross shape to form an intersection line, and
the intersection line is perpendicular to short sides of rectangular display frames and parallel to a horizontal direction when the projector is mounted.

2. The off-axis type projector according to claim 1, wherein the color separating unit and the color combining unit each is one of a cross dichroic prism achieved by combining plural prism blocks and a cross dichroic plate achieved by combining plural prism plates.

3. The off-axis type projector according to claim 2, wherein the color separating unit and the color combining unit is one cross dichroic prism.

4. The off-axis type projector according to claim 2, wherein the color separating unit and the color combining unit is one cross dichroic plate.

5. The off-axis type projector according to claim 1, wherein the off-axis type projector comprises an illumination optical system and a projection optical system, and the illumination optical system and the projection optical system has an arrangement juxtaposed with each other along the horizontal direction.

6. The off-axis type projector according to claim 1, wherein the off-axis type projector comprises an illumination optical system and a projection optical system, and an optical axis of the illumination optical system and an optical axis of the projection optical system are substantially in one plane.

7. The off-axis type projector according to claim 1, wherein a height dimension of the projector is substantially equal to a distance between the image display elements disposed above and below the color separating unit and the color combining unit.

8. The off-axis type projector according to claim 1, wherein the plural image display elements are liquid crystal panels.
